(19) United States
(12) Patent Application Publication
(10) Pub. No.: US 2022/0381027 A1
(43) Pub. Date: Dec. 1, 2022

(54) MULTILAYER ACOUSTIC AND SHOCK ABSORBING CUSHION

(71) Applicant: Web-Pro Corporation, Kaohsiung City (TW)

(72) Inventor: Cheng-Chung CHIU, Kaohsiung City (TW)

(21) Appl. No.: 17/750,059

(22) Filed: May 20, 2022

(30) Foreign Application Priority Data
May 25, 2021 (TW) 110118877

(51) Int. Cl. E04B 1/84; G10K 11/168; B32B 7/09; B32B 3/30; B32B 27/12

(52) U.S. Cl. CPC E04B 1/84; G10K 11/168; B32B 7/09; B32B 3/30; B32B 27/12; B32B 2307/102; B32B 2307/7265; B32B 2307/724; B32B 2307/56; E04B 2001/8414; E04B 2001/8461; B32B 2250/05; B32B 2250/40; B32B 2419/00; B32B 2607/00

(57) ABSTRACT

A multilayer acoustic and shock absorbing cushion, consisting of a buffer layer, two waterproof moisture-permeable layers respectively mounted on the corresponding two sides of the buffer layer, and two surface layers respectively mounted on each side of the waterproof moisture-permeable layers away from or at a distance from by the buffer layer. The buffer layer, each of the waterproof moisture-permeable layers, and each of the surface layers are needle punched and bonded to form a single body. The multilayer acoustic and shock absorbing cushion of the present invention is primarily used in building partitions and wall systems to prevent noise and vibration produced when household residents are doing physical activities from disturbing other neighbors. The multilayer acoustic and shock absorbing cushion is further provided with advantages including acoustic and shock absorbing functions, anti-efflorescence ability, and good cement bonding stability.

### BACKGROUND OF THE INVENTION

### (a) Field of the Invention

The present invention relates to a multilayer acoustic and shock absorbing cushion, and more particularly to a multilayer acoustic and shock absorbing cushion having application in a building as a floor, a wall partition, or as a wall system to separate apartments.

### (b) Description of the Prior Art

In order to accommodate more residents within a limited space, multi-unit housing has currently become mainstream in new construction projects in large cities. In multi-unit housing each household is close together, and thus unavoidably causes noise hindrance to neighbors when residents are doing physical activities, jumping, knocking against furniture, or rubbing against the floor. To cope with this problem, regulations imposed by the Construction and Planning Agency, Ministry of the Interior, R.O.C. requires that all new constructions or terraced residence extensions, separating walls of multi-unit housing, separating floors, and neighboring apartment walls and floors of elevator shafts and equipment rooms should additionally incorporate acoustic absorbing design to strengthen the tranquility and comfort of the apartment building surroundings, as well as minimize mutual disturbance and influence between apartments. The installation of a partition system generally requires rigid building material lining provided with acoustic absorbing and vibration damping effects, and largely uses cushion material. Construction methods can be roughly divided into two types, including dry construction methods (such as calcium silicate board and plasterboard combined with sound insulating foam) and wet construction methods (such as fiber cement siding combined with lightweight grouting material). In general, the absorption effect of the majority of noise is relatively better when the wet construction partition system is adopted compared to the dry construction method.

For example, European Union Patent No. EP2969533B1 provides a composite material, comprising a layer of a nonwoven structure and a foaming material fixed to the nonwoven structure. The composite material is provided with fireproofing and acoustic absorbing functions; however, because the nonwoven structure and the foaming material have many gaps, the cement easily seeps into the gaps during cement grouting, causing the nonwoven structure and foaming material to partially harden and lose flexibility, which further impairs the acoustic absorbing and vibration damping functions thereof.

Further, Taiwan Patent No. 201924894, provides a laminated board structure, comprising two cement boards and a vibration damping cushion sandwiched therebetween, wherein the vibration damping cushion is manufactured from discarded sponge, which after cutting undergoes heavy pressure and then thermal pressure. After the vibration damping cushion has undergone thermal pressure, the surface thereof does not have holes, and although it prevents cement from entering into the interior of the vibration damping cushion, however, it also results in it being difficult for the cement in contact with the vibration damping cushion to completely dry. Hence, moisture may still remain inside the vibration damping cushion, which after a long period of time may slowly seep out, causing an efflorescence phenomenon to occur in the caulked areas of ceramic tiles.

Further, Japan Patent No. JP6526922B2 provides a sound absorbing material, wherein one of the embodiments is provided with a non-woven fabric substrate impregnated with a water soluble polymer, and a thermosetting resin coated as a liquid on one side surface of the non-woven fabric substrate and dispersed with a filler, which undergo lamination to form a single body. The filler and thermosetting resin produce surface tension, which prevents the thermosetting resin from seeping out from the surface of the non-woven fabric substrate and reducing releasability during lamination, thus improving the outward appearance of the acoustic absorbing surface material. However, if this technical proposal is adopted and the sound absorbing material is used as a floor partition, after undergoing lamination, the surface of the non-woven fabric substrate is relatively smooth and level, and has inferior bondability with cement. Accordingly, due to floor bearing factors such as stress and earthquakes, problems including separation and deformation of the non-woven fabric substrate, the resin film, and the acoustic absorbing substrate component parts may occur in the sound absorbing material after a long-period of time.

Hence, in the current field of the invention there are still no technical proposals providing both good acoustic absorbing and vibration damping functions, anti-efflorescence, and component part stability, and therefore there is a need for improvement in the prior art.

### SUMMARY OF THE INVENTION

The object of the present invention lies in resolving the problems of vibration damping cushions of the prior art, such as cement seeping into the sound absorbing material and impairing the acoustic absorbing effect thereof, difficulty in cement moisture dissipating, resulting in efflorescence, and unideal bondability between the acoustic and shock absorbing material and cement, leading to distortion and deformation of component parts.

In order to achieve the aforementioned object, the present invention provides a multilayer acoustic and shock absorbing cushion, comprising a buffer layer, two waterproof moisture-permeable layers respectively mounted on the corresponding two sides of the buffer layer, and two surface layers respectively mounted on each of the waterproof moisture-permeable layers away from or at a distance from the buffer layer. The buffer layer, each of the waterproof moisture-permeable layers, and each of the surface layers are needle punched and bonded to form a single body.

Further, each of the surface layers enables grouting cement to seep therein, with the surface layers bonding to the cement after drying thereof.

Further, each of the surface layers comprises a plurality of needle-punched pre-needle punched fibers, each of which uses the needle punches from one of the surface layers to pass through the buffer layer and each of the waterproof moisture-permeable layers, and then entangled with the other surface layer.

Further, each of the pre-needle punched fibers of each of the surface layers is a group selectively structured from polypropylene, polyethylene, polyamide, or polyethylene terephthalate fiber.

Further, the material for the buffer layer is a group selectively structured from rubber, foaming material, glass wool, rock wool, fibrous body, or other composites.

Further, the buffer layer comprises a plurality of rubber particles, with a thermoplastic elastomer fused into each of the plurality of rubber particles.

Further, the material for the buffer layer is a group selectively structured from polyvinyl chloride (PVC), polyolefine, thermoplastic polyurethane (TPU), thermoplastic polyolefine, styrene-butadiene-styrene (SBS), styrene-isoprene-styrene (SIS), styrene-ethylene/butene-styrene (SEBS), hydrogenated styrene-butadiene-styrene (hSBS), acrylonitrile-butadiene-styrene (ABS), acrylonitrile-butadiene rubber, chloroprene rubber, Hypalon, natural rubber, butyl rubber, crosslinking reaction type elastomer, or other additives.

Further, the material for each of the waterproof moisture-permeable layers is a group selectively structured from a polyurethane formic acid-based film, Teflon film, thermoplastic resin film, thermoplastic plastic film, polyurethane film, or other composites.

Further, the waterproof moisture-permeable layers are porous structures.

Further, at least one side surface of the surface layers away from or at a distance from the waterproof moisture-permeable layers and the buffer layer is a nonplanar surface.

The non-woven fabric layer of the multilayer acoustic and shock absorbing cushion of the present invention provides for cement grouting, and after hardening thereof is firmly bonded to the cement. The waterproof moisture-permeable layers enable preventing moisture from entering the buffer layer, while the moisture-permeable effect of the waterproof moisture-permeable layers enables draining off excess moisture through diffusion or convection means. Needle punching is used to bond the buffer layer, each of the waterproof moisture-permeable layers, and each of the surface layers into a single body, while mutual needle punching and fiber entangling of the pre-needle punched fibers between each of the surface layers enable firm bondability, as well as maintaining an acoustic absorbing and vibration damping effect.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is a cross-sectional view of a multilayer acoustic and shock absorbing cushion of the present invention.

FIG. 2 is a cross-sectional view of a second embodiment mode of the multilayer acoustic and shock absorbing cushion of the present invention.

FIG. 3 is a cross-sectional view of a third embodiment mode of the multilayer acoustic and shock absorbing cushion of the present invention.

FIG. 4 is a cross-sectional view of a fourth embodiment mode of the multilayer acoustic and shock absorbing cushion of the present invention.

### DETAILED DESCRIPTION OF THE PREFERRED EMBODIMENTS

The technology, characteristics, and operation modes of the present application disclose several preferred embodiments, which in conjunction with a description of the diagrams are provided as reference for examination. Furthermore, the drawings of the present invention facilitate describing the proportions of embodiments disclosed, but are not necessarily drawn according to actual proportions. Moreover, the proportions in the drawings need not restrict the scope of the protected claims of the present invention.

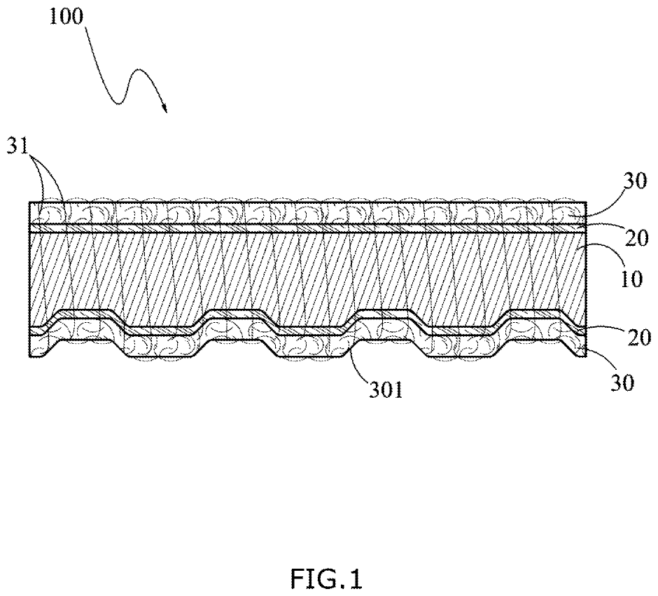

Regarding the technology of the present invention, please refer to FIG. 1, which shows an embodiment mode of a multilayer acoustic and shock absorbing cushion 100 of the present invention, which is bedded onto a building floor or wall surface to serve as an absorbent of vibration and noise; moreover, cement is grouted onto the exterior surface of the multilayer acoustic and shock absorbing cushion 100 as a fixing thereof.

The multilayer acoustic and shock absorbing cushion 100 comprises a buffer layer 10, two waterproof moisture-permeable layers 20 respectively mounted on the corresponding two sides of the buffer layer 10, and two surface layers 30 respectively mounted on each of the waterproof moisture-permeable layers 20 away from or at a distance from the buffer layer 10. The buffer layer 10, each of the waterproof moisture-permeable layers 20, and each of the surface layers 30 are needle punched to form a single body.

More specifically, the material for the buffer layer 10 can be a plastic elastomer, foaming material, glass wool, rock wool, fibrous body, or other composites. For example, the material for the buffer layer 10 is a group structured from polyvinyl chloride (PVC), polyolefine, thermoplastic polyurethane (TPU), thermoplastic polyolefine, styrene-butadiene-styrene (SBS), styrene-isoprene-styrene (SIS), styrene-ethylene/butene-styrene (SEBS), hydrogenated styrene-butadiene-styrene (hSBS), acrylonitrile-butadiene-styrene (ABS), acrylonitrile-butadiene rubber, chloroprene rubber, Hypalon, natural rubber, butyl rubber, crosslinking reaction type elastomer, or other admixtures. Taking into consideration the spirit of environmental protection and sustainable development, as well as conforming to green building material specifications, the material for the buffer layer 10 is preferably selected from the aforementioned materials that do not contain halogens. Because the buffer layer 10 is provided with elasticity, a damping effect is produced when impact-produced shock waves are transmitted therethrough, causing the shock wave amplitudes to die out. Moreover, the interior of the buffer layer 10 is preferably a porous structure, enabling the production of numerous partial reflections on the transmission paths of shock waves and neutralization thereof, thereby increasing the acoustic coupling impedance to achieve an acoustic absorbing effect. It is preferred that the buffer layer 10 selectively comprises a plurality of rubber particles, with a thermoplastic elastomer fused into each of the plurality of rubber particles. The aforementioned rubber particles can be obtained from cut-up discarded tires, which after undergoing hot melting naturally form the above-described porous structure, without the need for additional processing while further having the advantage of recycling resources. The thermoplastic elastomer can be polypropylene (PP), polyethylene (PE), polycarbonate (PC), polystyrene (PS), acrylonitrile-butadiene-styrene (ABS) copolymer, or polyamide (PA), which is used to bind together the rubber particles to form a single body. In addition, after mixing the thermoplastic elastomer and the rubber particles, the elasticity thereof further increases the shock absorbing effect of the rubber particles.

The material for each of the waterproof moisture-permeable layers 20 is a group selectively structured from a polyurethane formic acid-based film, Teflon film, thermoplastic resin film, thermoplastic plastic film, polyurethane film, or other composites, which are provided with the ability to resist water pressure and moisture-penetrability. In the present embodiment mode, the waterproof moisture-permeable layers 20 are provided with the ability to resist water pressure to a specified degree, preventing moisture from filtering into the buffer layers 10 when grouting with cement. It is preferred that the moisture vapor transmission rate (MVTR, ASTM E96-BW) of the waterproof moisture-permeable layers 20 lies between 100-5000 g/m2. 24 hrs, thus, after cement grouting cement, the waterproof moisture-permeable layers 20 is able to diffuse the excess moisture and vapor between each of the waterproof moisture-permeable layers 20 and each of the surface layers 30 to the outer edges; or the porous structure of the waterproof moisture-permeable layers 20 produces convection and evapotranspiration, which assists in drying the cement. Accordingly, moisture is prevented from remaining inside the multilayer acoustic and shock absorbing cushion 100, which would otherwise result in efflorescence crystallization or cause surface-attached ceramic tiles to distend because of the vapor. Furthermore, after laying the multilayer acoustic and shock absorbing cushion 100 on a building floor, cement grouting can be directly applied thereon, which provides the advantage of a simplified working procedure compared to traditional methods that first pour a layer of cement on a building floor and then lays an acoustic absorbing cushion thereon.

In the present embodiment mode, each of the surface layers 30 comprises a plurality of pre-needle punched fibers 31, each of which is a group selectively structured from polypropylene, polyethylene, polyamide, or polyethylene terephthalate fiber. Each of the pre-needle punched fibers 31 has been needle punched (not shown in the drawings), wherein the pre-needle punched fibers 31 is removed from one of the surface layers 30 and passed through the buffer layer 10 and each of the waterproof moisture-permeable layers 20, and then mutually entangled with each of the pre-needle punched fibers 31 of the other surface layer 30. A person having ordinary skill in the art should be able to understand that mechanical conditions of the multilayer acoustic and shock absorbing cushion 100, such as strength and thickness, and its application parameters on a needle punched board in a needle punch manufacturing process, such as needle density and needle diameter, should be adjusted according to actual application requirements of the wet construction partition method or wall system, and are not further detailed herein.

Before needle punching, each of the surface layers 30 is a pre-needle punched fiber structure, wherein the wording “pre-needle punched fiber structure” used in the present invention denotes a roughly fixed, fiber aggregate, similar to a fibrous fleece or fibrous mass that is formed after preprocessing and combining of each of the pre-needle punched fibers 31. After undergoing needle punching, each of the surface layers 30 still has a definite fluffiness and retains pores. Hence, during cement grouting, the cement, soaks in between the fluffy pores of the surface layers 30, and after the cement has dried and hardened, the surface layers 30 have bonded therewith into a single body, with excess cement being carried away from each of the waterproof moisture-permeable layers 20. According to the above-described structure, after each of the surface layers 30 has firmly bonded to the cement, even though the multilayer acoustic and shock absorbing and cushion 100 close to cement bears the stress produced by the weight of furniture arranged on the floor, because each of the pre-needle punched fibers 31 penetrates the buffer layer 10 and entangles therewith to form a single body, thus the multilayer acoustic and shock absorbing and cushion 100 is able to assimilate the stress and will not experience the problems of warping, splitting into layers, or deforming, and will not separate from the cement.

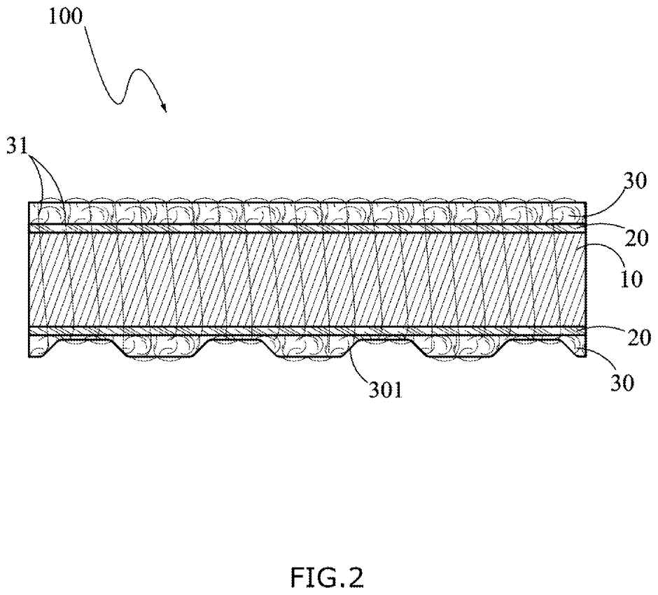

In addition, to further improve the acoustic absorbing and vibration damping effect, at least one side surface of the surface layers 30 is a nonplanar surface 301 that is formed away from or at a distance from the waterproof moisture-permeable layer 20 and the buffer layer 10. In the present embodiment mode, the nonplanar surface 301 corresponds to a building floor, and is away from or at a distance from the side where cement grouting is applied. Hence, gaps are formed between the nonplanar surface 301 and the building floor when the multilayer acoustic and shock absorbing cushion 100 is laid thereon. When vibrations or noise is transmitted between the nonplanar surface 301 and the floor, the interface produced by the gaps causes a scattering and reflecting phenomenon to occur on the vibrations or sound waves which further reduces the amplitudes thereof. Further. the present invention does not limit the shape type of the nonplanar surface 301. Referring to the embodiment mode shown in FIG. 1, after producing a nonplanar shape on one side of the buffer layer 10, the respective waterproof moisture-permeable layer 20 and surface layer 30 are perfectly fitted to the nonplanar surface of the buffer layer 10, thereby indirectly forming the nonplanar surface 301; or as depicted in FIG. 2, which shows a second embodiment mode of the present invention, which adopts an embossed method, whereby the nonplanar surface 301 is directly formed on one side of the surface layer 30 away from or at a distance from each of the waterproof moisture-permeable layers 20. Accordingly, the nonplanar surface 301 is only formed on the outer surface of the surface layer 30 and belongs to the technical content of the claims of the present invention; moreover, the claims of the present invention do not limit the shape type of the outer surface.

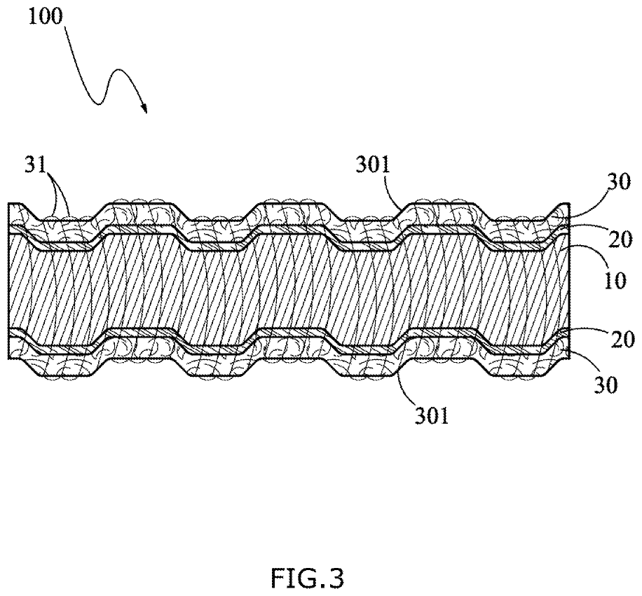

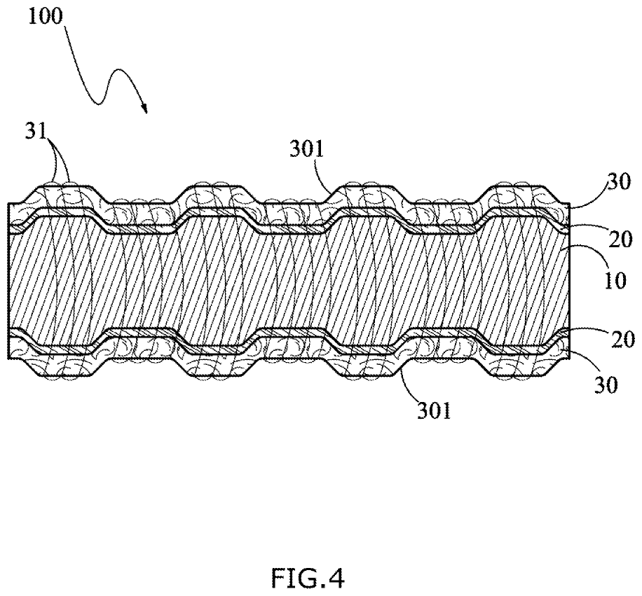

Referring to FIG. 3, which shows a third embodiment mode of the present invention, wherein the nonplanar surface 301 is formed on the outer surface of each of the surface layers 30. A builder lays the multilayer acoustic and shock absorbing cushion 100 on the building floor, and then proceeds with cement grouting on top thereof, whereas the gaps in the nonplanar surface 301 in contact with the building floor remain unfilled to achieve the anticipated acoustic absorbing effect. The nonplanar surface 301 on the other side in contact with the cement has a relatively flat surface type to form a greater contact area with the cement, accordingly attaining superior cement bondability. Further, referring to FIG. 4, which shows a fourth embodiment mode of the present invention, the overall structure of which is similar to the third embodiment mode of the present invention; however, the nonplanar surfaces 301 have a mutually dispersed configuration. In the X-direction of FIG. 4, each of the nonplanar surfaces 301 concurrently form concave and convex undulations, thereby providing the multilayer acoustic and shock absorbing cushion 100 with different thicknesses, which enables designing the degree of acoustic absorbing and vibration damping thereof according to different requirements.

In conclusion, the multilayer acoustic and shock absorbing cushion 100 of the present invention uses a needle punching method to mutually join each of the surface layers 30, each of the waterproof moisture-permeable layers 20, and the buffer layer 10. Each of the surface layers 30 is available for cement grouting, and after hardening thereof is firmly bonded to the cement. Each of the waterproof moisture-permeable layers 20 enables preventing moisture from entering the buffer layer 10, while at the same time is provided with a moisture-permeable effect, which enables excess moisture to drain off the buffer layer 10 using a diffuse or convection method. Needle punching is used to bind each of the waterproof moisture-permeable layers 20 and each of the surface layers 30 into a single body, and through mutual entangling of the pre-needle punched fibers 31, enables preventing problems such as separation and deformation of component parts.

The above provides a detailed description of the content of the present invention; however, it is to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A multilayer acoustic and shock absorbing cushion, comprising:
a buffer layer;
two waterproof moisture-permeable layers respectively mounted on corresponding two sides of the buffer layer; and
two surface layers respectively mounted on each side of the waterproof moisture-permeable layers are away from the buffer layer;
the buffer layer, each of the waterproof moisture-permeable layers, and each of the surface layers are needle punched and bonded to form an integral.

2. The multilayer acoustic and shock absorbing cushion according to claim 1, wherein each of the surface layers is capable of grouting and seeping in of cement, and after hardening thereof the surface layer is firmly bonded to the cement.

3. The multilayer acoustic and shock absorbing cushion according to claim 2, wherein each of the surface layers having a plurality of pre-needle punched fibers, applied by using needle punch from one of the surface layers to pass through the buffer layer and each of the waterproof moisture-permeable layers, and then entangled with the other surface layer.

4. The multilayer acoustic and shock absorbing cushion according to claim 3, wherein each of the pre-needle punched fibers of each of the surface layers is a group selectively structured from polypropylene, polyethylene, polyamide, or polyethylene terephthalate fiber.

5. The multilayer acoustic and shock absorbing cushion according to claim 1, wherein the material for the buffer layer is a group selectively structured from rubber, foaming material, glass wool, rock wool, fibrous body, or other composites.

6. The multilayer acoustic and shock absorbing cushion according to claim 5, wherein the buffer layer having a plurality of rubber particles, with a thermoplastic elastomer fused into each of the plurality of rubber particles.

7. The multilayer acoustic and shock absorbing cushion according to claim 5, wherein the material for the buffer layer is a group selectively structured from polyvinyl chloride (PVC), polyolefine, thermoplastic polyurethane (TPU), thermoplastic polyolefine, styrene-butadiene-styrene (SBS), styrene-isoprene-styrene (SIS), styrene-ethylene/butene-styrene (SEBS), hydrogenated styrene-butadiene-styrene (hSBS), acrylonitrile-butadiene-styrene (ABS), acrylonitrile-butadiene rubber, chloroprene rubber, Hypalon, natural rubber, butyl rubber, crosslinking reaction type elastomer, or other admixtures.

8. The multilayer acoustic and shock absorbing cushion according to claim 1, wherein the material for each of the waterproof moisture-permeable layers is a group selectively structured from a polyurethane formic acid-based film, Teflon film, thermoplastic resin film, thermoplastic plastic film, polyurethane film, or other composites.

9. The multilayer acoustic and shock absorbing cushion according to claim 1, wherein the waterproof moisture-permeable layers are porous structures.

10. The multilayer acoustic and shock absorbing cushion according to claim 1, wherein at least one side surface of the surface layers is away from from the waterproof moisture-permeable layers and the buffer layer is a nonplanar surface.
